(19) United States
(12) Patent Application Publication
(10) Pub. No.: US 2009/0237856 A1
(43) Pub. Date: Sep. 24, 2009

(54) SOLENOID VALVE DRIVE CONTROL APPARATUS AND METHOD FOR DRIVING A SOLENOID VALVE

(75) Inventors: Nobuyuki ISHITSUKA, Satte-shi (JP); Fumio Morikawa, Misato-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC Kabushiki Kaisha, Chiyoda-ku (JP)

(21) Appl. No.: 12/366,152

(22) Filed: Feb. 5, 2009

(30) Foreign Application Priority Data
Mar. 19, 2008 (JP) 2008-072057

(51) Int. Cl. H01H 47/00

(52) U.S. Cl. 361/160

(57) ABSTRACT

A solenoid valve drive control apparatus includes a MOSFET connected in series with the drive coil of a solenoid valve, a varistor connected in parallel with the drive coil, and a diode connected in parallel with the drive coil and the MOSFET. Due to the MOSFET being turned OFF, because the varistor immediately becomes conductive when a back EMF is generated in the drive coil, an electric current caused by the back EMF flows through a closed circuit constituted by the drive coil and the varistor.

### BACKGROUND OF THE INVENTION

1. Field of the Invention

The present invention relates to a solenoid valve drive control apparatus and to a method for driving a solenoid valve, in which a drive coil of the solenoid valve is energized and the solenoid valve is driven thereby.

2. Description of the Related Art

Heretofore, it has been known to provide a solenoid valve drive control apparatus, which stops energization of the drive coil and halts driving of the solenoid valve, at some time after the drive coil has been energized and the solenoid valve has been placed in a driven state. In such a solenoid valve drive control apparatus, because the drive coil is connected in parallel with a diode (flywheel diode), when energizing of the drive coil is stopped, a comparatively large back EMF (back electromotive force) is generated, and a current (flywheel current) caused by the back EMF flows inside of a closed circuit constituted by the drive coil and the diode. In this case, the electromagnetic energy (an electromagnetic energy corresponding to the back EMF) of the solenoid valve is consumed by the diode as heat energy, and driving of the solenoid valve is halted by reducing the current to a zero level. However, due to the presence of the diode, because the current continues to flow through the closed circuit over a comparatively long period of time, a delay in response is generated, in relation to halting the driven condition of the solenoid valve.

Consequently, in Japanese Laid-Open Patent Publication No. 63-297881, a proposal is offered in which a series circuit made up of the flywheel diode and a transistor is connected in parallel with the drive coil, wherein by turning OFF the transistor and interrupting the flywheel current, the time during which the flywheel current flows is shortened. Further, in Japanese Laid-Open Patent Publication No. 04-354106, a proposal is made in which a transistor that functions as the flywheel diode is connected in parallel with the drive coil, wherein the time during which the flywheel current flows is shortened by turning OFF the transistor.

Notwithstanding, according to the techniques proposed in Japanese Laid-Open Patent Publication No. 63-297881 and Japanese Laid-Open Patent Publication No. 04-354106, in order to turn the transistor connected in parallel with the drive coil ON and OFF, the solenoid valve drive control apparatus must be equipped with a switching circuit including the transistor and a control circuit that generates a control signal for turning the transistor ON and OFF. Therefore, the circuit structure of the solenoid valve drive control apparatus becomes complex, which makes the circuit design difficult and leads to an increase in costs.

### SUMMARY OF THE INVENTION

The present invention has the object of enabling improvements in response characteristics pertaining to halting the driven state of a solenoid valve by means of a simple circuit structure.

More specifically, to achieve the aforementioned object, according to the present invention, in the case that a solenoid valve drive control apparatus includes a switch connected in series with a drive coil of a solenoid valve, a varistor connected in parallel with the drive coil, and a diode connected in parallel with the drive coil and the switch, after the drive coil is energized and the solenoid valve is driven in a state in which the switch is in an ON state, the switch is turned OFF.

In this case, since the varistor forms a voltage dependent resistor, the resistance value of which changes in accordance with the value of the voltage imposed on the varistor, when an OFF state of the switch is caused and a comparatively large back EMF is generated in the drive coil, the resistance value is decreased immediately by the back EMF, whereupon the varistor is rendered conductive. Owing thereto, a current caused by the back EMF flows inside a closed circuit constituted by the drive coil and the varistor.

That is, according to the present invention, because the current flows inside of a closed circuit constituted by the drive coil and the varistor, and not inside of a closed circuit made up of the drive coil and the diode as in the conventional technique, electromagnetic energy stored in the solenoid valve (i.e., electromagnetic energy corresponding to the back EMF) is consumed as heat energy in the varistor. As a result, compared to the conventional technique, the current can be reduced to a zero level in a short time period.

Accordingly, in the present invention, by placing the switch in an OFF state, together with rendering the varistor conductive corresponding to the back EMF, the current caused by the back EMF during the drive stop time of the solenoid valve does not flow through a diode, so that responsiveness in relation to stopping driving of the solenoid valve can be improved by means of a simpler circuit structure.

The solenoid drive control apparatus may further include a power source terminal through which a power source voltage is supplied to the drive coil through the switch, and a switching control means connected to the power source terminal, for controlling the ON and OFF states of the switch based on the power source voltage.

Owing thereto, during ON states of the switch, the power source voltage is supplied to the drive coil from the power source terminal through the switch (i.e., is energized electrically) whereupon driving of the solenoid valve is enabled, and the power supply terminal can be used in common as a terminal for supply of voltage to the switching control means, as well as a terminal for energizing of the drive coil.

In this case, the switch may comprise a semiconductor element having a control terminal connected to the switching control means, wherein the switching control means generates a control signal based on the power source voltage, and the semiconductor element is turned ON and OFF by the control signal, which is supplied to the control terminal from the switching control means.

Owing thereto, control of the ON and OFF states of the switch can easily be performed. Further, since it is sufficient for the semiconductor element simply to be a semiconductor element that is capable of being turned ON and OFF by the control signal and which is capable of supplying the power source voltage to the drive coil from the power source terminal, the solenoid valve drive control apparatus can be manufactured at a low cost.

Furthermore, preferably, the switching control means comprises a series circuit made up of a first resistor and a second resistor, the series circuit being connected to the power supply terminal, wherein the control terminal is connected to a connection point between the first resistor and the second resistor, and wherein the semiconductor element regards a voltage at the connection point based on the power source voltage as the control signal, and is turned ON and OFF thereby.

Because the switching control means is constituted by the first resistor and the second resistor, the solenoid valve drive control apparatus can be realized at a low cost and by means of a simple circuit structure. Further, since the voltage at the connection point is regarded as the control signal, the control signal can be generated easily. Moreover, because the voltage is treated as the control signal, a semiconductor element of a voltage controlled type such as an FET, or a MOSFET, can be adopted for use as the semiconductor element.

In addition, preferably, the varistor is rendered conductive when a voltage in a parallel circuit made up of the drive coil and the varistor becomes greater than the power source voltage.

As a result, while the power source voltage is being supplied from the power source terminal and through the switch to the drive coil for driving the solenoid valve, rendering the varistor conductive, and flowing of current inside the closed circuit constituted by the drive coil and the varistor can reliably be prevented. Together therewith, by turning the switch OFF, when the back EMF, which is greater than the power source voltage, is generated in the drive coil, the varistor immediately becomes conductive and the current is made to flow reliably inside the closed circuit.

Preferably, the varistor is a zinc oxide varistor.

Such a zinc oxide varistor is an electronic element that is widely available in the market and can easily be acquired. Therefore, the solenoid valve drive control apparatus can be manufactured at a low cost.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a circuit diagram of a solenoid valve drive control apparatus according to an embodiment of the present invention;

FIG. 2 is a time chart showing a drive control for the solenoid valve performed by the solenoid valve drive control apparatus of FIG. 1;

FIG. 3 is a circuit diagram of a solenoid valve drive control apparatus according to a comparative example; and

FIG. 4 is a time chart showing a drive control for the solenoid valve performed by the solenoid valve drive control apparatus of FIG. 3.

### DESCRIPTION OF THE PREFERRED EMBODIMENTS

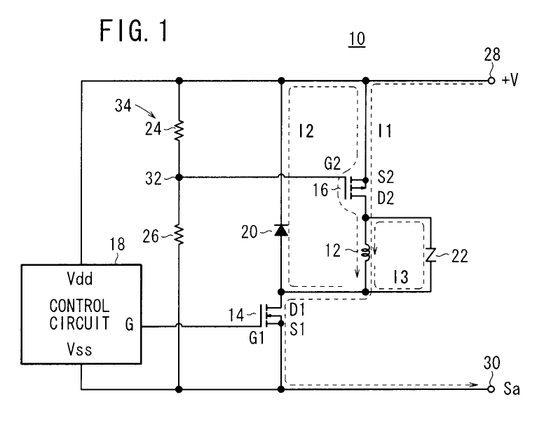

As shown in FIG. 1, a solenoid valve drive control apparatus 10 according to the present embodiment forms a device for energizing a drive coil 12 of the solenoid valve, thereby driving the solenoid valve, including an N-channel MOSFET 14, a P-channel MOSFET (switch, semiconductor element) 16, a control circuit 18 constituted by a microprocessor or the like, a diode 20 that functions as a flywheel diode, a varistor 22 that utilizes a zinc oxide varistor therein, a first resistor 24, and a second resistor 26.

In this case, the MOSFET 16, the drive coil 12 and the MOSFET 14 are connected in series between a power source terminal 28, to which a power source voltage V is externally supplied, and a control input terminal 30, to which a drive command signal Sa having a low potential (e.g., ground potential) is supplied. Further, the varistor 22 is connected in parallel with the drive coil 12, and the diode 20 is connected in parallel with the series circuit made up of the MOSFET 16 and the drive coil 12.

Furthermore, the first resistor 24 and the second resistor 26 are connected in a series circuit between the power source terminal 28 and the control input terminal 30. Still further, a power source input terminal Vdd of the control circuit 18 is connected to the power source terminal 28, a control input terminal Vss is connected to the control input terminal 30, and a control output terminal G is connected to a gate terminal G1 of the MOSFET 14.

Accordingly, the series circuit made up of the MOSFET 16, the drive coil 12 and the MOSFET 14, the series circuit made up of the first resistor 24 and the second resistor 26, and the control circuit 18, are connected together in parallel between the power source terminal 28 and the control input terminal 30. Further, a connection point 32 of the first resistor 24 and the second resistor 26, which make up a switching control means 34, is connected to a gate terminal G2 of the MOSFET 16.

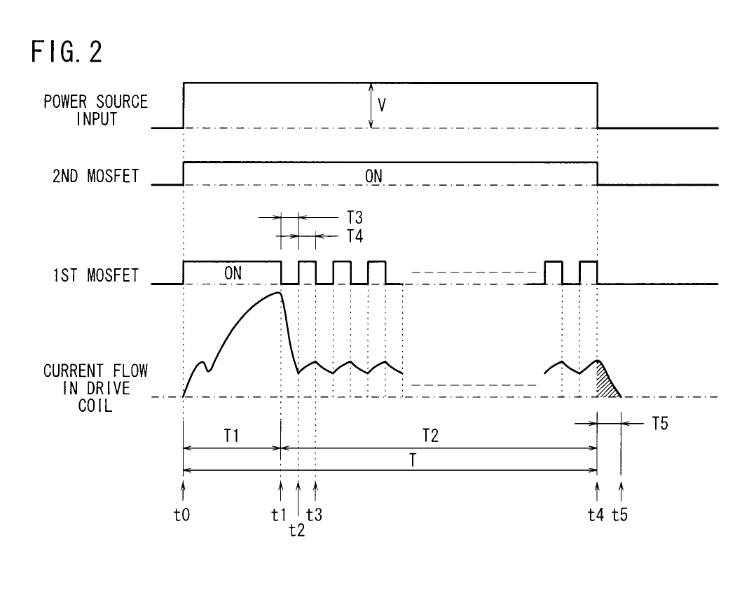

Next, an explanation shall be made, with reference to FIG. 1 and the time chart of FIG. 2, concerning operations (in a method for driving the solenoid valve) of the solenoid valve drive control apparatus 10 according to the present embodiment.

As shown in FIG. 2, in the solenoid valve drive control apparatus 10, for driving the solenoid valve, energizing is carried out in a rated energizing mode with respect to the drive coil 12 (see FIG. 1) for a preset first time period T1 inside of a predetermined drive command interval T, and a power saving energizing mode is performed with respect to the drive coil 12 during a remaining second time period T2.

In actuality, in the solenoid valve drive control apparatus 10, the drive command interval T and a predetermined OFF period (a period during which the solenoid valve is stopped) after the drive command interval T, are considered to form one cycle period, and driving of the solenoid valve is repeatedly carried out over a plurality of such cycle periods. However, in the following explanations, operation of the solenoid valve drive control apparatus 10 over one such cycle period shall be described.

Further, the aforementioned rated energizing mode is defined as an energizing method in which, within the first time period T1, a power source voltage V, which is a rated voltage of the drive coil 12, is applied for driving (initiating movement of) the solenoid valve, wherein the power source voltage V is applied to the drive coil 12 from the power source terminal 28 through the MOSFET 16, under a condition in which the MOSFET 14 (the 1st MOSFET in FIG. 2) and the MOSFET 16 (the 2nd MOSFET in FIG. 2) are both in an ON state (i.e., wherein the duty ratio of an ON state of the MOSFET 14 and the MOSFET 16 is 100%).

Furthermore, the aforementioned power saving energizing mode is defined as an energizing method in which, during the second time period T2 after the first time period T1, while the MOSFET 16 remains in an ON state, the MOSFET 14 is repeatedly turned ON and OFF (at an OFF period T3 and an ON period T4), whereby the solenoid valve is driven (i.e., the driven state of the solenoid valve is maintained) at a reduced power, which is lower than the rated energizing power applied with respect to the drive coil 12.

First, at time t0, when the power source voltage V is supplied externally to the power source terminal 28 and the potential of the control input terminal 30 is a drive command signal Sa having a low potential (e.g., ground potential), a drive command interval T is initiated.

Upon initiation of the drive command interval T, the power source voltage V is supplied (imposed) from the power source terminal 28 on the side of the power input terminal Vdd of the control circuit 18 and the first resistor 24 of the switching control means 34, whereas on the other hand, the drive control signal Sa is supplied from the control input terminal 30 on the side of the control input terminal Vss and the second resistor 26 of the switching control means 34. As a result, within the first time period T1 from time t0 to time t1, in the control circuit 18, a control signal (a pulse signal having a pulse width of T1) is generated at a 100% drive duty ratio, and is supplied to the gate terminal G1 of the MOSFET 14. Further, in the switching control means 34, the voltage at the connection point 32, which is a divided voltage formed by dividing the power source voltage V based on the resistance value of each of the first resistor 24 and the second resistor 26, is regarded as the control signal, and is supplied to (imposed on) the gate terminal G2 of the MOSFET 16.

In accordance therewith, during the first time period T1, the MOSFET 14 is rendered conductive (turned ON) between the drain terminal D1 and the source terminal S1 thereof by a control signal, which is supplied to the gate terminal G1 from the control circuit 18. On the other hand, the MOSFET 16 is rendered conductive (turned ON) between the source terminal S2 and the drain terminal D2 thereof by a control signal, which is supplied to the gate terminal G2 from the connection point 32. As a result, the power source voltage V is applied to the drive coil 12 from the power source terminal 28 through the MOSFET 16, whereupon the rated energizing mode with respect to the drive coil 12 is carried out to initiate movement of the solenoid valve.

As shown in FIG. 1, the path I1 from the power source terminal 28, through the MOSFET 16, the drive coil 12 and the MOSFET 14 to the control input terminal 30, indicates the path of the current that flows in the drive coil 12 during the first time period T1. Further, the first time period T1 is set to a sufficient time interval, so as to enable movement of the solenoid valve to be initiated by application of the power source voltage V with respect to the drive coil 12, whereby the movable element inside the solenoid valve is moved and attracted to the fixed iron core.

Next, after completion of the first time period T1, in the second time period T2 from time t1 until time t4, the control circuit 18 stops supplying the control signal to the gate terminal G1 in the OFF period T3 and supplies the control signal to the gate terminal G1 in the ON period T4, repeatedly, thereby carrying out a power saving energizing mode under a PWM (pulse width modulated) control. In this case, the OFF period T3 is defined by a time interval from time t1 to time t2, whereas the ON period T4 is defined by a time interval from time t2 to t3. Accordingly, the control signal is formed by a repeating pulse signal having a duty ratio of T4/(T3+T4).

At the OFF period T3, since the control signal is not supplied to the gate terminal G1 from the control circuit 18, the MOSFET 14 is switched from an ON state into an OFF state, between the drain terminal D1 and the source terminal S1 thereof, whereupon energizing of the drive coil 12 is stopped. As a result, in the closed circuit (the closed circuit indicated by path I2 in FIG. 1) constituted by the drive coil 12, the MOSFET 16 and the diode 20, a current caused by the electromagnetic energy of the solenoid valve, which was stored in the drive coil 12, is made to flow, and the electromagnetic energy thereof is consumed through the diode 20. Moreover, since the OFF period T3 is set comparatively short, the attracted condition of the movable element to the fixed iron core is maintained, or the movable element is separated only slightly from the fixed iron core.

On the other hand, in the ON period T4, since the control signal is supplied from the control circuit 18 to the gate terminal G1, the MOSFET 14 is switched from an OFF state into an ON state, between the drain terminal D1 and the source terminal S1 thereof, whereupon energizing of the drive coil 12 is reinitiated, and the current flowing in the drive coil 12 flows along the path I1 of FIG. 1. In this case, attraction of the movable element to the fixed iron core is maintained, or the movable element which has separated only slightly from the fixed iron core, or which is about to separate from the fixed iron core, is once again attracted firmly by the fixed iron core.

By repeatedly performing sequential operations of the OFF period T3 and the ON period T4 from time t1 until time t4 (until the drive command interval T is completed), the power saving energizing mode is carried out with respect to the drive coil 12, while the driven state of the solenoid valve is maintained. Moreover, the second time period T2 can be optionally set, corresponding to a desired driving time for the controlled object (fluid device) of the solenoid valve. Further, even during the second time period T2, since the power source voltage V is supplied in an ongoing manner from the power source terminal 28 to the switching control means 34, the MOSFET 16 is maintained in an ON state (see FIG. 2).

Additionally, at time t4, since supply of the power source voltage V from the exterior to the power source terminal 28 is terminated, and supply of the power source voltage V to the power source input terminal Vdd of the control circuit 18 and to the side of the first resistor 24 of the switching control means 34 also is stopped, generation of the respective control signals from the control circuit 18 and the switching control means 34, and supply of such control signals to the gate terminals G1, G2, also is halted. As a result, the MOSFETs 14 and 16 are switched from the ON state into an OFF state, whereupon energizing of the drive coil 12 is stopped. By terminating electrical energizing of the drive coil 12, a back EMF caused by the electromagnetic energy is generated in the drive coil 12, which is greater than the power source voltage V.

At this time, in the varistor 22, a zinc oxide varistor is adopted, wherein the resistance value of the varistor on which the voltage larger than the power source voltage V is imposed is immediately lowered to make the varistor conductive. Therefore, if the voltage, which is generated due to the MOSFET 16 being turned OFF in the parallel circuit made up of the drive coil 12 and the varistor 22, is the back EMF that is greater than the power source voltage V, the resistance value of the varistor 22 is lowered immediately at time t4. As a result, the varistor 22 assumes a conductive state, and a current caused by the back EMF flows inside of the closed circuit constituted by the drive coil 12 and the varistor 22 (the closed circuit indicated by path I3 in FIG. 1). Accordingly, the electromagnetic energy is consumed as heat energy in the varistor 22, resulting in the current being reduced to a zero level in a short time during the transition period T5 from time t4 to time t5 (the period indicated by the slanted line, in FIG. 2). As a result, the movable element separates immediately from the fixed iron core, and the solenoid valve rapidly assumes a stopped state.

The construction and operation of the solenoid valve and the control circuit 18 are well known (for example, as disclosed in Japanese Laid-Open Patent Publications 2007-024281 and 2007-177818), and therefore details concerning such features have been omitted from the present specification.

Next, explanations shall be made concerning the advantages and effects of the solenoid valve drive control apparatus 10 and the method for driving a solenoid valve according to the present embodiment.

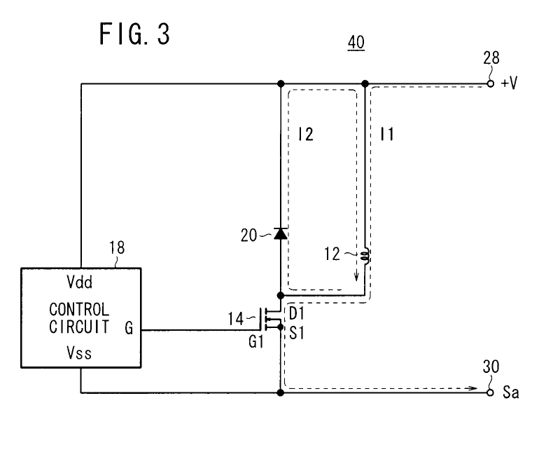

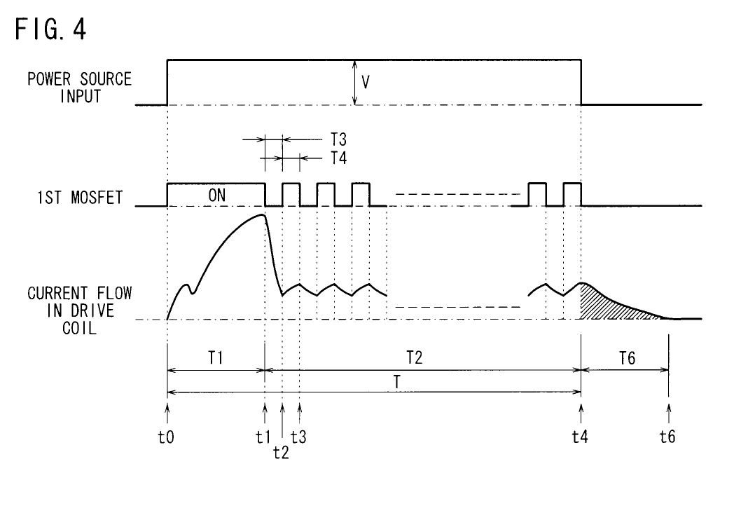

FIG. 3 is a circuit diagram of a solenoid valve drive control apparatus 40 according to a conventional technique (comparative example). FIG. 4 is a time chart showing a drive control for the solenoid valve, which is performed by the solenoid valve drive control apparatus 40. In FIG. 3 and FIG. 4, structural elements, which are the same as those shown in FIGS. 1 and 2, are designated by the same reference numerals, and detailed explanations of such features have been omitted.

In the solenoid valve drive control apparatus 40 according to the comparative example, at time t4, when the MOSFET 14 is turned OFF and energizing of the drive coil 12 is halted, a current caused by a back EMF generated in the drive coil 12 flows inside of a closed circuit (the closed circuit indicated by path I2 in FIG. 3) constituted by the drive coil 12 and the diode 20. In this case, because the current flows through the diode 20, and the electromagnetic energy of the solenoid valve is consumed inside of the closed circuit, the current continues to flow inside of the closed circuit over a comparatively long period of time (for the transition period T6, from time t4 until time t6, as indicated by the slanted line in FIG. 4), and a response delay in relation to stopping the driven state of the solenoid valve is generated.

In contrast thereto, according to the present embodiment, the solenoid valve drive control apparatus 10 (see FIG. 1) includes the MOSFET 16 connected in series with the drive coil 12 of the solenoid valve, the varistor 22 connected in parallel with the drive coil 12, and the diode 20 connected in parallel with the drive coil 12 and the MOSFET 16. After the drive coil 12 is energized and the solenoid valve is driven with the MOSFET 16 in an ON state (during the drive command interval T), the MOSFET 16 is turned OFF.

In this case, because the varistor 22 is a voltage-dependent resistor, the resistance value of which changes in accordance with the value of the voltage imposed on the varistor 22, when the MOSFET 16 is turned OFF and a comparatively large back EMF is generated in the drive coil 12, the resistance value is reduced immediately by the back EMF, and the varistor 22 is rendered conductive. Therefore, the current caused by the back EMF flows within a closed circuit (the closed circuit indicated by the path I3 in FIG. 1) constituted by the drive coil 12 and the varistor 22.

More specifically, in the present embodiment, the current does not flow in the closed circuit (the closed circuit indicated by the path I2 in FIG. 3) constituted by the drive coil 12 and the diode 20 as in the comparative example, but rather, flows in the closed circuit (the closed circuit indicated by the path I3 in FIG. 1) constituted by the drive coil 12 and the varistor 22. Therefore, the electromagnetic energy (electromagnetic energy corresponding to the back EMF) stored in the solenoid valve is consumed as heat energy in the varistor 22. As a result, in contrast to the comparative example, the current can be reduced to a zero level in a shorter period of time (T5<T6).

Accordingly, in the present embodiment, by preventing the current caused by the back EMF when the driven state of the solenoid valve is stopped from flowing through the diode 20, in accordance with the OFF state of the MOSFET 16 and the conductivity of the varistor 22 corresponding to the back EMF, the responsiveness of the solenoid valve in relation to stopping driving thereof can be improved by means of a simple circuit structure.

Further, the solenoid valve drive control apparatus 10 includes the power source terminal 28 for supplying the power source voltage V to the drive coil 12 through the MOSFET 16, and the switching control means 34 connected to the power source terminal 28, for controlling ON and OFF states of the MOSFET 16 based on the power source voltage V. Therefore, during the period of time (the drive command interval T) when the MOSFET 16 is ON, the power source voltage is supplied to (i.e., energizes) the drive coil 12 from the power source terminal 28 through the MOSFET 16, thereby enabling the solenoid valve to be driven, and the power source terminal 28 can be used in common as a terminal for supply of voltage to the switching control means 34, as well as a terminal for energizing of the drive coil 12.

Furthermore, because the MOSFET 16 is turned ON and OFF between the power source terminal 28 and the drive coil 12 based on a control signal from the switching control means 34, control of the ON and OFF states can easily be performed, and the solenoid valve drive control apparatus 10 can be manufactured inexpensively.

Still further, because the switching control means 34 is constituted by the first resistor 24 and the second resistor 26, the solenoid valve drive control apparatus 10 can be realized by means of a simple circuit structure and at a low cost. Further, since the voltage of the connection point 32 is regarded as the control signal supplied to the gate terminal G2, the control signal can easily be generated. Moreover, in the present embodiment, ON and OFF states performed by the MOSFET 16 have been described. However, because the voltage is taken as the control signal, even if the MOSFET 16 were replaced by other types of voltage controlled type semiconductor elements (for example, a FET), the same advantages and effects of the present embodiment could easily be obtained.

In addition, because the varistor 22 is rendered conductive when the voltage in the parallel circuit made up of the drive coil 12 and the varistor 22 becomes greater than the power source voltage V, while the power source voltage V is being supplied to the drive coil 12 from the power source terminal 28 through the MOSFET 16 for driving the solenoid valve, rendering the varistor 22 conductive and flowing of current in the closed circuit constituted by the drive coil 12 and the varistor 22 can reliably be prevented. Together therewith, due to the MOSFET 16 being turned OFF, when the back EMF (back electromotive force) greater than the power source voltage V is generated in the drive coil 12, the varistor 22 immediately becomes conductive and the current is made to flow reliably inside the closed circuit.

Further, preferably, a zinc oxide varistor is adopted for use as the varistor 22. Such a zinc oxide varistor is an electronic element that is widely available in the market and can easily be acquired. Therefore, the solenoid valve drive control apparatus 10 can be manufactured at a low cost.

The present invention is not limited to the aforementioned embodiments. It is a matter of course that various other structures or modifications could be adopted, based on the content of the present specification and drawings, as disclosed herein.

What is claimed is:

1. A solenoid valve drive control apparatus comprising:
a switch connected in series with a drive coil of a solenoid valve;
a varistor connected in parallel with the drive coil; and
a diode connected in parallel with the drive coil and the switch,
wherein, after the drive coil is energized and the solenoid valve is driven in a condition in which the switch is in an ON state, the switch is turned OFF.

2. The solenoid valve drive control apparatus according to claim 1, further comprising:
a power source terminal through which a power source voltage is supplied to the drive coil through the switch; and
a switching control means connected to the power source terminal, for controlling the ON and OFF states of the switch based on the power source voltage.

3. The solenoid valve drive control apparatus according to claim 2, wherein:
the switch comprises a semiconductor element having a control terminal connected to the switching control means;
the switching control means generates a control signal based on the power source voltage; and
the semiconductor element is turned ON and OFF by the control signal, which is supplied to the control terminal from the switching control means.

4. The solenoid valve drive control apparatus according to claim 3, wherein:
the switching control means comprises a series circuit made up of a first resistor and a second resistor, the series circuit being connected to the power source terminal;
the control terminal is connected at a connection point between the first resistor and the second resistor; and
the semiconductor element regards a voltage at the connection point based on the power source voltage as the control signal, and is turned ON and OFF thereby.

5. The solenoid valve drive control apparatus according to claim 2, wherein the varistor is rendered conductive when a voltage in a parallel circuit made up of the drive coil and the varistor becomes greater than the power source voltage.

6. The solenoid valve drive control apparatus according to claim 1, wherein the varistor is a zinc oxide varistor.

7. A method for driving a solenoid valve, in which a switch is connected in series with a drive coil of a solenoid valve, a varistor is connected in parallel with the drive coil, and a diode is connected in parallel with the drive coil and the switch, comprising the step of:
turning the switch OFF, after the drive coil is energized and the solenoid valve is driven in a condition in which the switch is in an ON state.
